(19) United States
(12) Patent Application Publication
(10) Pub. No.: US 2002/0089855 A1
(43) Pub. Date: Jul. 11, 2002

(54) Lamp shade structure

(76) Inventor: Juang Mei Ju, Shulin City (TW)

Correspondence Address: BACON & THOMAS, PLLC, 625 Slaters Lane - 4th Floor, Alexandria, VA, 22314-1176, US

(21) Appl. No.: 09/756,755

(22) Filed: Jan. 10, 2001

(51) Int. Cl. F21V 11/00

(52) U.S. Cl. 362/351; 362/355; 362/357

(57) ABSTRACT

Knockdown lamp shade structure including a frame body composed of an upper and a lower brackets and multiple support ribs and a shade body embracing the frame body. The support ribs are connected between the upper and lower brackets to define a hollow frame body in which a bulb seat is disposed. The support ribs are detachably assembled with the upper and lower brackets, whereby the volume of the lamp shade can be minimized to facilitate storage and transfer of large amount of products.

### BACKGROUND OF THE INVENTION

The present invention is related to an improved lamp shade structure, and more particularly to a knockdown lamp shade structure which can be easily assembled and disassembled to minimize the volume of the lamp shade so as to facilitate storage and transfer of large amount of products.

A conventional lamp shade structure includes a frame body and a shade body embracing the frame body for concentrating light beam and enhancing illuminating effect. In order to have sufficient structural strength and ensure safety, the conventional frame body is generally made of metal rods which are cut into a certain length and welded with each other to form the frame body. The shade body is made of a sheet of fabric or paper material and embraces the frame body to form the lamp shade structure.

Such frame body has rigid structure. However, after welded, the frame body cannot be disassembled and will occupy much room. Therefore, when storing or transferring a large amount of products, very much room will be occupied to lead to great inconvenience in storage and transfer. This results in increased cost and is not economic.

### SUMMARY OF THE INVENTION

It is therefore a primary object of the present invention to provide a knockdown lamp shade structure in which the components of the lamp shade are easily detachably assembled with each other to form the lamp shade. When storing or transferring large amount of lamp shades, the lamp shades can be disassembled to minimize the occupied volume for facilitating storage and transfer of the lamp shades without affecting the structural strength or rigidity thereof.

The present invention can be best understood through the following description and accompanying drawings wherein:

### BRIEF DESCRIPTION OF THE DRAWINGS

FIG. 1 is a perspective assembled view of the lamp shade structure of the present invention;

FIG. 2 is a perspective exploded view of the lamp shade structure of the present invention;

FIG. 3 is a perspective partially exploded view of the lamp shade structure of the present invention; and

FIG. 4 is a perspective exploded and collapsed view of the lamp shade structure of the present invention.

### DETAILED DESCRIPTION OF THE PREFERRED EMBODIMENT

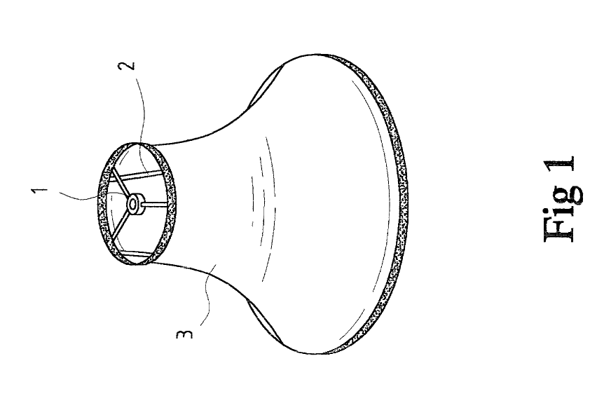

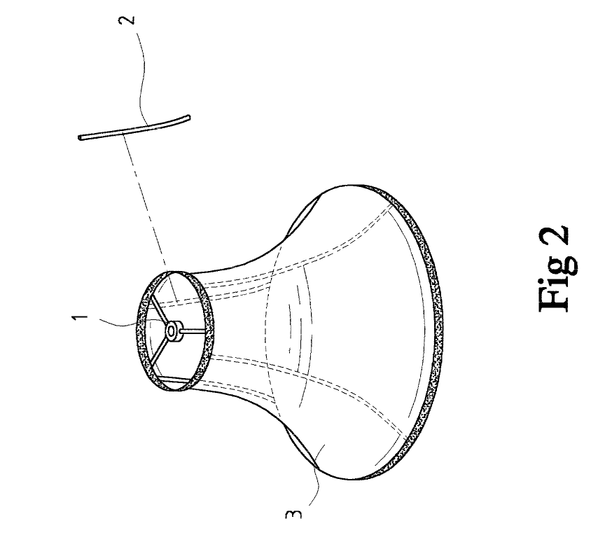

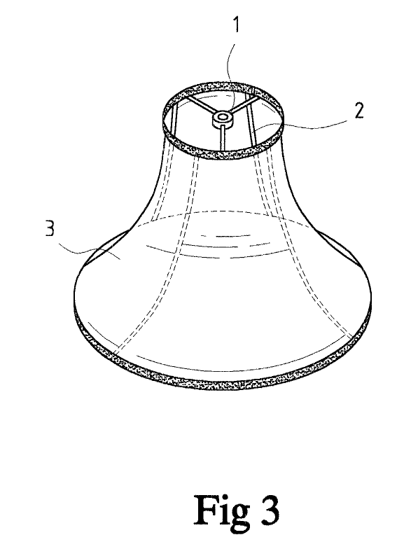

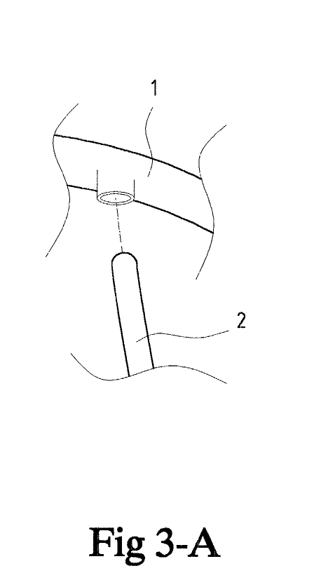

Please refer to FIGS. 1 to 3. The lamp shade structure of the present invention includes a frame body composed of an upper and a lower brackets 1 and multiple support ribs 2 and a shade body 3 embracing the frame body.

The support ribs 2 are connected between the upper and lower brackets 1 to define a hollow frame body in which a bulb seat is disposed. The support ribs 2 can be assembled with and disassembled from the upper and lower brackets 1.

The shade body 3 is made of soft fabric or paper material and is integrally sewn with the upper and lower brackets 1. The support ribs 2 are connected between the upper and lower brackets 1 by insertion to stretch the shade body 3 into a trumpet-shaped body.

Prior to assembly, the upper and lower brackets 1 and the shade body 3 and the multiple support ribs 2 are respectively collectively stored to reduce occupied room and facilitate transfer.

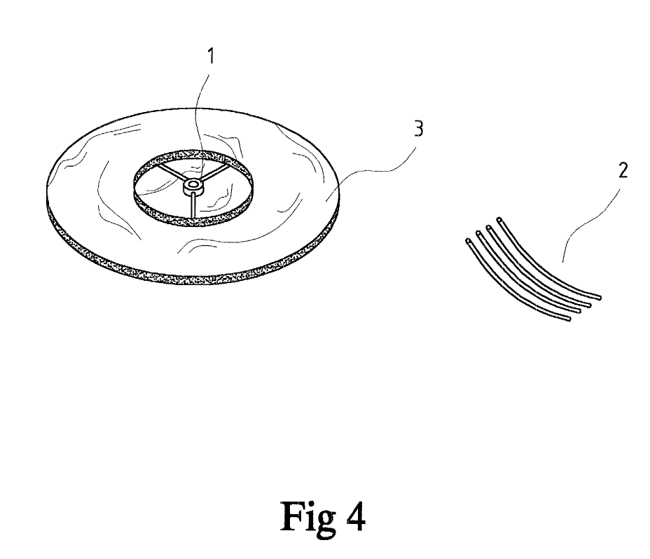

The upper and lower brackets 1 are formed with connecting structures for connecting with the support ribs 2, whereby the support ribs 2 can be detachably connected between the upper and lower brackets 1 to define a frame body having an internal receiving space. The shade body 3 embraces the frame body to form the lamp shade structure. Each support rib 2 is independent from the other. When not used, the support ribs 2 can be detached from the upper and lower brackets 1 and collectively stored so as to minimize the volume of the lamp shade structure as shown in FIG. 4. In mass-production, the components of the lamp shade are separately stored to facilitates transfer and reduce occupied room.

The above embodiment is only used to illustrate the present invention, not intended to limit the scope thereof. Many modifications of the above embodiment can be made without departing from the spirit of the present invention.

What is claimed is:

1. Lamp shade structure comprising a frame body composed of an upper and a lower brackets and multiple support ribs and a shade body embracing the frame body, said lamp shade structure being characterized in that:
the support ribs are connected between the upper and lower brackets to define a hollow frame body in which a bulb seat is disposed, the support ribs being detachably assembled with the upper and lower brackets without affecting the structural strength or rigidity of the lamp shade; and
the shade body is made of soft fabric or paper material and is integrally sewn with the upper and lower brackets, the support ribs being connected between the upper and lower brackets by insertion to stretch the shade body into a trumpet-shaped body.
